(19) United States
(12) Patent Application Publication
(10) Pub. No.: US 2009/0327975 A1
(43) Pub. Date: Dec. 31, 2009

(54) Multi-Touch Sorting Gesture

(76) Inventor: Roy W. Stedman, Austin, TX (US)

Correspondence Address: HAMILTON & TERRILE, LLP, P.O. BOX 203518, AUSTIN, TX, 78720, US

(21) Appl. No.: 12/163,201

(22) Filed: Jun. 27, 2008

(51) Int. Cl. G06F 3/033

(52) U.S. Cl. 715/863

(57) ABSTRACT

A method and apparatus are provided for recognizing multi-touch gestures on a touch sensitive display. A plurality of graphical objects is displayed within a user interface (UI) of a display screen operable to receive touch input. A first touch input exceeding a first time duration is detected over a first graphical object. A touch-and-hold gesture action is generated, which is then applied to the first graphical object. A second touch input is then detected over a second graphical object and a touch-select gesture action is generated, which is then applied to the second graphical object. The first and second gestures are processed to determine an associated operation, which is then performed on the second graphical object.

### BACKGROUND OF THE INVENTION

1. Field of the Invention

The present invention relates to information handling systems and more particularly to recognizing multi-touch gestures on a touch sensitive display.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The way that users interact with information handling systems has continued to evolve. For example, graphical user interfaces (GUIs) have become increasingly popular in recent years, not only for computer systems, but for various mobile and small form factor electronic devices as well. It is generally accepted that the implementation of a GUI not only makes these systems and devices easier to use, but also facilitates the user in learning how to use them. In the past, a user typically interacted with a GUI using a keyboard and a mouse. Over time, other input devices have become available for performing GUI interactions, including trackballs, touch pads, and joy sticks, each of which has attendant advantages and disadvantages. More recently, the use of touch screens has become popular as they generally enable a user to enter input and make selections in a more natural and intuitive manner.

Touch screens typically have a touch-sensitive, transparent panel that covers the surface of a display screen. The user interacts with the GUI by pointing with a stylus or a finger to graphical objects displayed on the touchscreen. The touchscreen detects the occurrence and position of the touch input, interprets the touch input as a touch event, and then processes the touch event to perform a corresponding action. In some cases, additionally touch input functionality can be provided through the implementation of gestures. As an example, one or more predetermined actions can be performed when a corresponding sequence of taps are detected on the surface of a touchscreen.

While known gesturing approaches are able to recognize a sequence of touch inputs, they are limited in that they are typically unable to recognize concurrent or sequential of touch inputs on separate graphical objects. As a result, the number of gestures that may be recognized, and the corresponding actions they may invoke, is limited. For example, lack of multi-select input prevents the ability to select multiple graphical objects and then simultaneously perform a move or other operation on them while leaving other objects unaffected. In view of the foregoing, there is a need for recognizing multi-select input from a user as a gesture to perform a simultaneous operation on a predetermined group of graphical objects.

### SUMMARY OF THE INVENTION

In accordance with the present invention, a method and apparatus are provided for recognizing multi-touch gestures on a touch sensitive display. In various embodiments, a plurality of graphical objects is displayed within a user interface (UI) of a display screen operable to receive touch input from a user. The display screen is then monitored to detect touch input over a first graphical object. If the touch input exceeds a first time duration, the coordinates of the first graphical object are provided to the operating system (OS) controlling the operation of the display screen. A touch-and-hold gesture action is generated, which is then applied to the first graphical object. The display screen is then monitored to detect a touch input over a second graphical object. In one embodiment, the touch-and-hold gesture action is terminated if the first touch input is ended prior to the detection of a second touch input over a second graphical object. In another embodiment, the touch-and-hold gesture action is terminated if a second duration of time expires before a second touch input over a second graphical object is detected.

If a touch input has been detected over a second graphical object within the second time duration, then the coordinates of the second graphical object are provided to the operating system (OS) controlling the operation of the display screen. A touch-select gesture action is generated, which is then applied to the second graphical object. In one embodiment, the first touch input is detected as a result of a first finger on a hand of a user being in contact with a first graphical object and the second touch input is detected as a result of a second finger being in contact with a second graphical object. In another embodiment, the display screen is operable to perform palm-rejection on a touch input. If the palm of a user hand comes into contact with the UI, it is not detected as either a first or second touch input and is accordingly rejected.

In these and other embodiments, the first and second gestures are processed to determine an associated operation. In one embodiment, if the first graphical object is a file folder and the second graphical object is a file, then the associated operation is determined to be a file move operation. In another embodiment, if the first graphical object is an application program and the second graphical object is a file, then the associated operation is determined to be a file execution operation. In this embodiment, the file corresponding to the second graphical object is executed by the application program corresponding to the first graphical object when the associated operation is performed. The associated operation is then performed on the second graphical object(s).

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of components of an information handling system as implemented in the method and apparatus of the present invention;

FIGS. 2a-b are a flowchart for recognizing multi-touch gestures on a touch sensitive display;

FIGS. 3a-b show the recognition of multi-touch gestures to move multiple objects within a graphical user interface (GUI) of a touch sensitive display; and

FIGS. 4a-b show the recognition of multi-touch gestures to perform operations on multiple objects within a graphical user interface (GUI) of a touch sensitive display.

### DETAILED DESCRIPTION

A method and apparatus are disclosed for recognizing multi-touch gestures on a touch sensitive display. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

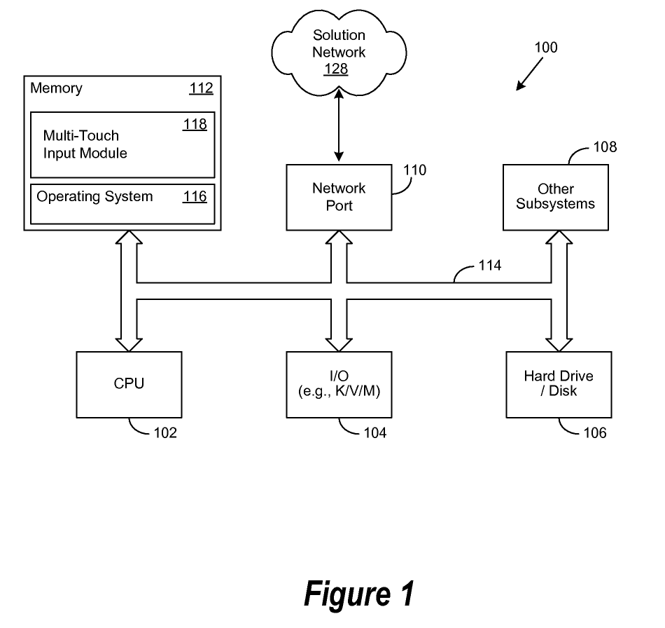

FIG. 1 is a generalized illustration of components of an information handling system 100 as implemented in the method and apparatus of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other storage subsystems 108. In various embodiments, the information handling system 100 also includes network port 110 operable to connect to a network 128. The information handling system 100 likewise includes system memory 112, which is interconnected to the foregoing via one or more buses 114. System memory 112 further comprises operating system (OS) 116 and a multi-touch input module 118.

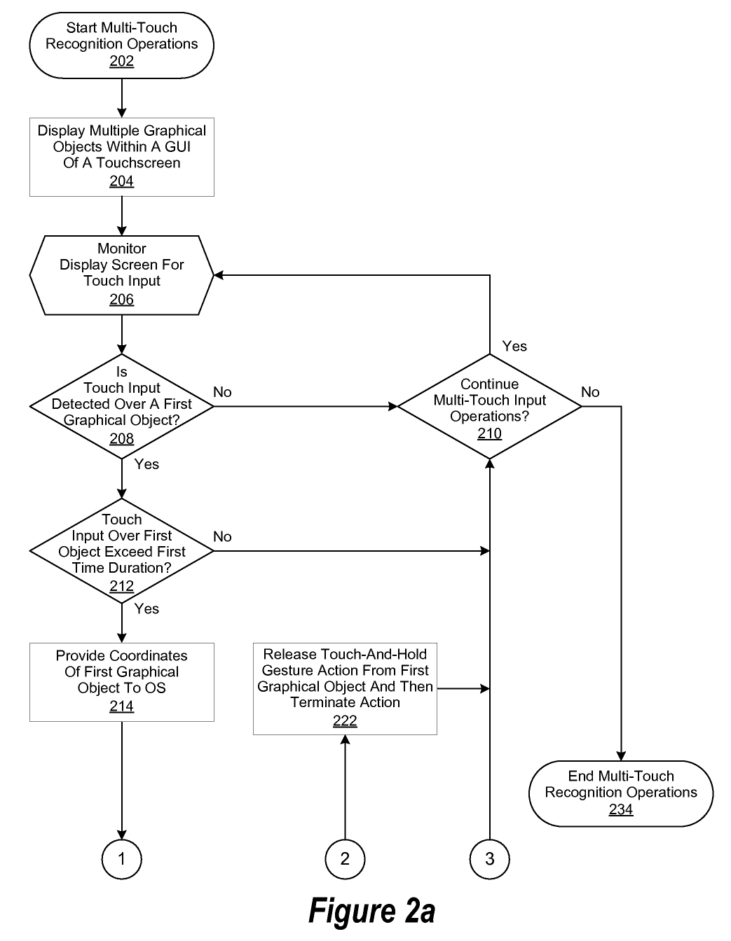

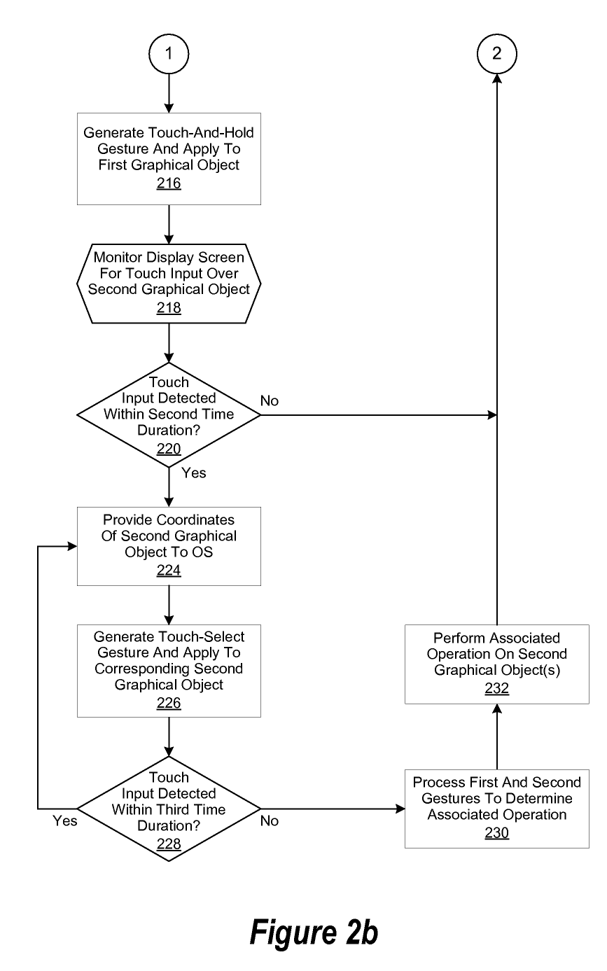

FIGS. 2a-b are a flowchart for recognizing multi-touch gestures on a touch sensitive display as implemented in an embodiment of the invention. In this embodiment, multi-touch recognition operations are begun in step 202, followed by the display of a plurality of graphical objects in a user interface (UI) of a display screen operable to receive touch input from a user. In step 206, the display screen is monitored to detect touch input from a user. In step 208, a determination is made whether a touch input has been detected over a first graphical object within the UI of the display screen. If not, then a determination is made in step 210 whether to continue multi-touch recognition operations. If so, then the process continues, proceeding with step 206. Otherwise, multi-touch recognition operations are ended in step 234.

However, if it is determined in step 208 that a touch input has been detected over a first graphical object, then a determination is made in step 212 whether the touch input has exceeded a first time duration. If not, then a determination is made in step 210 whether to continue multi-touch recognition operations. If so, then the process continues, proceeding with step 206. Otherwise, multi-touch recognition operations are ended in step 234. Otherwise, the coordinates of the first graphical object are provided in step 214 to the operating system (OS) controlling the operation of the display screen. A touch-and-hold gesture action is generated, which is then applied to the first graphical object in step 216. As an example, the first time duration may be set to two seconds. If the duration of the touch input over the first graphical object exceeds two seconds, then the touch input is interpreted to simulate a touch-and-hold user gesture. If the duration of the touch input over the first graphical object is less than two seconds, it is not.

The display screen is then monitored in step 218 to detect a touch input over a second graphical object. A determination is then made in step 220 whether a touch input over a second graphical object has been detected within a second time duration. If not, then the process continues, proceeding with step 222 where the touch-and-hold gesture action is first released from the first graphical object and then terminated. As an example, the second time duration may be set to five seconds. If a touch input over a second graphical object is not detected within five seconds, then the touch-and-hold gesture action applied to the first graphical object is considered to be a possible user error. As a result, the previously generated touch-and-hold gesture action is first released from the first graphical object and then terminated. A determination is then made in step 210 whether to continue multi-touch recognition operations. If so, then the process continues, proceeding with step 206. Otherwise, multi-touch recognition operations are ended in step 234.

However, if it is determined in step 220 that a touch input has been detected over a second graphical object within the second time duration, then the coordinates of the second graphical object are provided to the operating system (OS) in step 224. A touch-select gesture action is generated, which is then applied to the second graphical object in step 226. A determination is then made in step 228 whether a touch input over another second graphical object has been detected within a third time duration. As an example, the third time duration may be set to one second. A user performs a touch input over a first graphical object for a time duration of over two seconds. As a result, a select-and-hold gesture action is generated for the first graphical object. The user then selects a second graphical object within the second time duration of five seconds and another second graphical object within the third time duration of one second. Accordingly, a user-select gesture for each of the second graphical objects is interpreted by the OS controlling the operation of the display screen.

If it is determined in step 228 that a touch input over another second graphical object has been detected within the third time duration, the process is continued, proceeding with step 224. If not, then the first and second gestures are processed in step 230 to determine an associated operation. In one embodiment, if the first graphical object is a file folder and the second graphical object is a file, then the associated operation is determined to be a file move operation. In this embodiment, the file corresponding to the second graphical object is moved into the file folder corresponding to the first graphical object when the associated operation is performed. In another embodiment, if the first graphical object is an application program and the second graphical object is a file, then the associated operation is determined to be a file execution operation. In this embodiment, the file corresponding to the second graphical object is executed by the application program corresponding to the first graphical object when the associated operation is performed. The associated operation is then performed on the second graphical object(s) in step 232. The process is continued, proceeding with step 222 where the touch-and-hold gesture action is first released from the first graphical object and then terminated. A determination is then made in step 210 whether to continue multi-touch recognition operations. If so, then the process continues, proceeding with step 206. Otherwise, multi-touch recognition operations are ended in step 234.

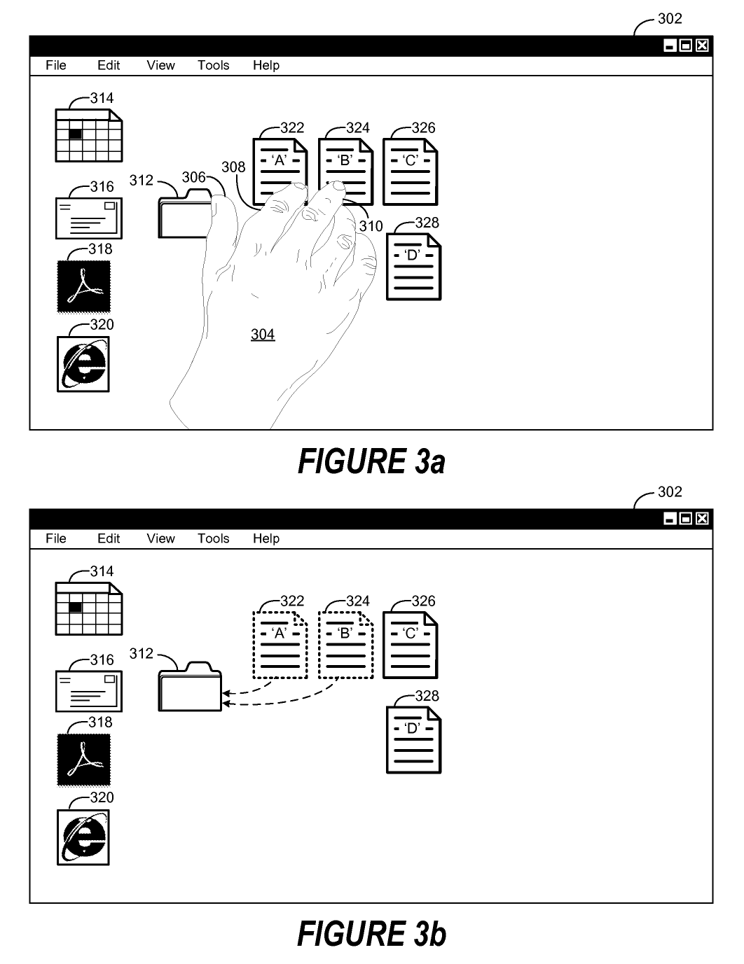

FIGS. 3a-b show the recognition of multi-touch gestures to move multiple objects within a graphical user interface (GUI) of a touch sensitive display. As shown in FIG. 3a, the GUI 302 of a display screen comprises a plurality graphical objects, including a calendar application 314, an electronic mail (email) application 316, a document reader application 318, and a Web browser 320. The GUI 302 likewise comprises file folder 312 and document files ‘A’ 322, ‘B’ 324, ‘C’ 326, and ‘D’ 328.

In one embodiment, a first touch input is detected as a result of a first finger (e.g., a thumb) 306 on a hand 304 of a user being in proximate contact with a first graphical object (e.g., file folder 312). If the duration of the touch input over the first graphical object (e.g., file folder 312) exceeds a first predetermined time duration, then the touch input is interpreted to simulate a touch-and-hold user gesture. A second touch input is detected as a result of a second finger 308 on a hand of a user 304 being in proximate contact with a second graphical object (e.g., document file ‘A’ 322) and interpreted as a touch-select gesture action. A second touch input is likewise detected as a result of a another second finger 310 on a hand of a user 304 being in proximate contact with another second graphical object (e.g., document file ‘B’ 324) and is also interpreted as a touch-select gesture action. The first and second gestures are then processed to determine an associated operation. As shown in FIG. 3b, if the first graphical object is file folder 312 and the second graphical objects are document files ‘A’ 322 and ‘B’ 324, then the associated operation is determined to be a file move operation. In one embodiment, the document files ‘A’ 322 and ‘B’ 324 are moved into the file folder 312 when the associated operation is performed.

In another embodiment, the touch-and-hold gesture action is terminated if the first touch input is ended prior to the detection of a second touch input. In yet another embodiment, the touch-and-hold gesture action is terminated if a second touch input is not detected within a predetermined time period. In still another embodiment, the display screen is operable to perform palm-rejection on a touch input. As used herein, palm-rejection is defined as the ability to recognize the difference between the palm of a user hand 304 versus a thumb 306 or fingers 308, 310 a user hand 304 of coming into contact with GUI 302. If the palm of user hand 304 comes into contact with the GUI 302, it is not detected as either a first or second touch input and is accordingly rejected.

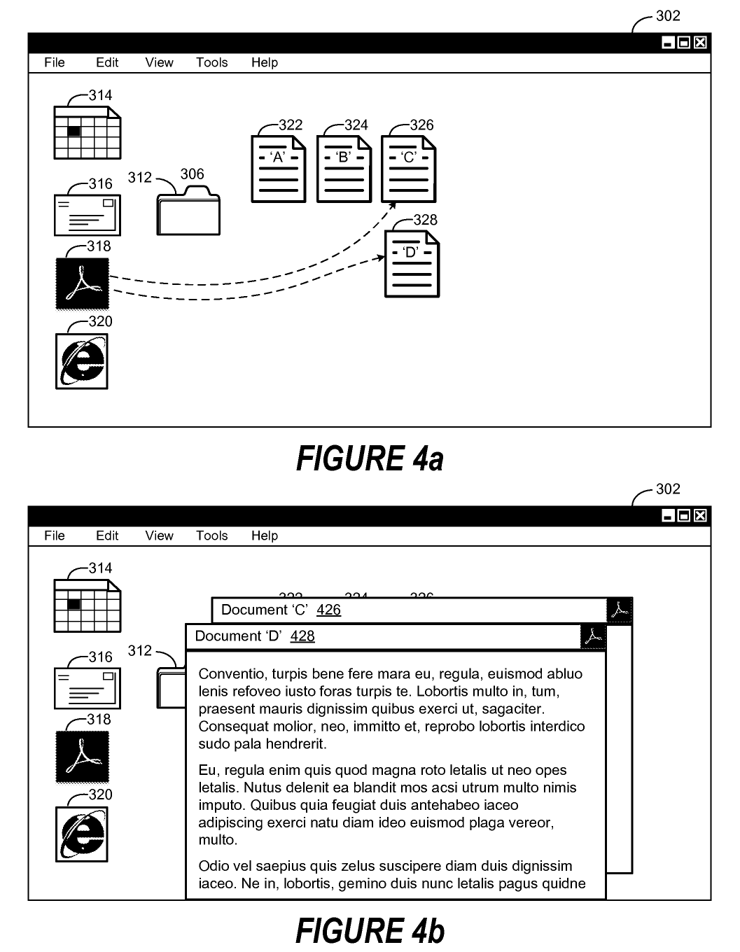

FIGS. 4a-b show the recognition of multi-touch gestures to perform operations on multiple objects within a graphical user interface (GUI) of a touch sensitive display. As shown in FIG. 4a, a first touch input is detected as a result of a first finger (e.g., a thumb) 306 on a hand 304 of a user being in proximate contact with a first graphical object (e.g., document reader application 318). If the duration of the touch input over the first graphical object (e.g., file folder 312) exceeds a first predetermined time duration, then the touch input is interpreted to simulate a touch-and-hold user gesture. A second touch input is detected as a result of a second finger 308 on a hand of a user 304 being in proximate contact with a second graphical object (e.g., document file ‘C’ 326) and interpreted as a touch-select gesture. A second touch input is likewise detected as a result of a another second finger 310 on a hand of a user 304 being in proximate contact with another second graphical object (e.g., document file ‘D’ 328) and is also interpreted as a touch-select gesture. The first and second gestures are then processed to determine an associated operation. As shown in FIG. 4b, if the first graphical object is document reader application 318 and the second graphical objects are document files ‘C’ 326 and ‘D’ 328, then the associated operation is determined to be a file execution operation. In one embodiment, the document files ‘C’ 326 and ‘D’ 328 are executed and displayed as document ‘C’ 426 and document ‘D’ 428 when the associated operation is performed.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for recognizing multi-touch input on a display screen, the method comprising:
displaying a plurality of graphical objects in a user interface of a display screen operable to receive touch input from a user;
detecting a first touch input associated with a first graphical object, the first touch input lasting a first duration of time;
generating a gesture action if the first duration of time is longer than a first reference amount of time; and
detecting a second touch input associated with a second graphical object.

2. The method of claim 1, wherein:
the first touch input is detected as a result of a first finger on a hand of a user being in proximate contact with the first graphical object; and
the second touch input is detected as a result of a second finger on a hand of a user being in proximate contact with the second graphical object.

3. The method of claim 1, wherein:
the generated gesture action simulates a touch-and-hold user gesture, the touch-and-hold gesture applied to the first graphical object; and
the second touch input is a touch-select user gesture, the touch-select gesture applied to the second graphical object.

4. The method of claim 1, wherein the second touch input is performed within a second reference amount of time subsequent to the generation of the gesture action.

5. The method of claim 1, further comprising:
processing the first and second touch inputs to determine an operation to be performed on the second graphical object
performing the operation on the second graphical object.

6. The method of claim 5, wherein the operation performed on the second graphical object results in the second graphical object being moved to the first graphical object.

7. The method of claim 5, wherein the operation performed on the second graphical object results in the second graphical object being executed by the first graphical object.

8. The method of claim 1, further comprising:
terminating the generated gesture action, responsive to an occurrence of a terminating event.

9. The method of claim 8, wherein the terminating event includes one of a:
detection of an end of the first touch input prior to the detecting of a second touch input; and
expiration of the second reference amount of time before the detecting of a second touch input.

10. The method of claim 1, wherein the display screen is operable to perform palm-rejection on a touch input.

11. An apparatus for recognizing multi-touch input on a display screen, the apparatus comprising:
means to display a plurality of graphical objects in a user interface of a display screen operable to receive touch input from a user;
means to detect a first touch input associated with a first graphical object, the first touch input lasting a first duration of time;
means to generate a gesture action if the first duration of time is longer than a first reference amount of time; and
means to detect a second touch input associated with a second graphical object.

12. The apparatus of claim 11, wherein:
the first touch input is detected as a result of a first finger on a hand of a user being in proximate contact with the first graphical object; and
the second touch input is detected as a result of a second finger on a hand of a user being in proximate contact with the second graphical object.

13. The apparatus of claim 11, wherein:
the generated gesture action simulates a touch-and-hold user gesture, the touch-and-hold gesture applied to the first graphical object; and
the second touch input is a touch-select user gesture, the touch-select gesture applied to the second graphical object.

14. The apparatus of claim 11, wherein the second touch input is performed within a second reference amount of time subsequent to the detection of the first touch input.

15. The apparatus of claim 11, further comprising:
means to process the first and second touch inputs to determine an operation to be performed on the second graphical object
means to perform the operation on the second graphical object.

16. The apparatus of claim 15, wherein the operation performed on the second graphical object results in the second graphical object being moved to the first graphical object.

17. The apparatus of claim 15, wherein the operation performed on the second graphical object results in the second graphical object being executed by the first graphical object.

18. The apparatus of claim 11, further comprising:
means to terminate the generated gesture action, responsive to an occurrence of a terminating event.

19. The apparatus of claim 18, wherein the terminating event includes one of a:
detection of an end of the first touch input prior to the detecting of a second touch input; and
expiration of the second reference amount of time before the detecting of a second touch input.

20. The apparatus of claim 11, wherein the display screen is operable to perform palm-rejection on a touch input.
